(19) United States
(12) Patent Application Publication
(10) Pub. No.: US 2026/0132806 A1
(43) Pub. Date: May 14, 2026

(54) MOVEMENT STRUCTURE

(71) Applicant: FIVEGRAND INTERNATIONAL CO., LTD., New Taipei City (TW)

(72) Inventor: TING-JUI WANG, New Taipei City (TW)

(73) Assignee: FIVEGRAND INTERNATIONAL CO., LTD., New Taipei City (TW)

(21) Appl. No.: 19/236,881

(22) Filed: Jun. 12, 2025

(30) Foreign Application Priority Data
Nov. 8, 2024 (TW) 113142940

(51) Int. Cl. F16B 2/16; F16B 2/18

(52) U.S. Cl. CPC F16B 2/16; F16B 2/185

(57) ABSTRACT

The present disclosure introduces a movement structure, including a body, an actuating part, and a moving part. The actuating part is movably combined with the body. The moving part is arranged on the body. The actuating part moves to make the moving part move, so as to make the moving part buckled to a buckled part. In this way, the body can be arranged on an object, and the moving part can be buckled to or unbuckled from the buckled part through the actuating part, so as to achieve rapid combination and separation of at least two objects, thereby ensuring repetitive and rapid combination and separation.

### CROSS-REFERENCE TO RELATED APPLICATION

This non-provisional application claims priority under 35 U.S.C. § 119(a) on Patent Application No(s). 113142940 filed in Taiwan, R.O.C. on Nov. 8, 2024, the entire contents of which are hereby incorporated by reference.

### BACKGROUND OF THE INVENTION

### 1. Field of the Invention

The present disclosure relates to a movement structure, and in particular to a movement structure that can make at least two objects to be repetitively and rapidly combined and separated.

### 2. Description of the Related Art

Generally, when combining at least one object, screws are configured to lock to achieve combination of objects.

In terms of the conventional fixing method mentioned above, although at least one object can be fixed and combined in a way that is not easy to separate, the assembly process is complicated, and the fixing and combination method using screws may also cause the at least one object to be difficult to disassemble.

In view of the above conventional technique, the inventor invents a movement structure, where a body can be arranged on an object, and a moving part can be buckled to or unbuckled from a buckled part through an actuating part, so as to achieve rapid combination and separation of at least two objects, thereby ensuring repetitive and rapid combination and separation.

### BRIEF SUMMARY OF THE INVENTION

In a movement structure according to the present disclosure, a body can be arranged on an object, and a moving part can be buckled to or unbuckled from a buckled part through an actuating part, so as to achieve rapid combination and separation of at least two objects, thereby ensuring repetitive and rapid combination and separation.

In order to achieve the above objective and other objectives, the present disclosure provides a movement structure, including a body, an actuating part, and a moving part. The actuating part is movably combined with the body. The moving part is arranged on the body. The actuating part moves to make the moving part move, so as to make the moving part buckled to a buckled part.

The present disclosure provides a movement method of another movement structure. The movement structure includes a body, an actuating part, and a moving part, where the actuating part is movably combined with the body, the moving part is arranged on the body, and the actuating part moves to make the moving part move, so as to make the moving part buckled to a buckled part.

Optionally, the body is provided with at least one first stopping part, the actuating part is provided with at least one second stopping part, and the first stopping part and the second stopping part are elastically deformable, or the first stopping part and the second stopping part are elastically deformable and movable.

Optionally, the actuating part is connected to an operating part through a coupling part, the operating part rotates against the body or any object to drive the actuating part to move, or the operating part moves to generate high-position movement and low-position movement to drive the actuating part to move.

Optionally, the actuating part is connected to an operating part through a coupling part, and the operating part moves to drive the actuating part to move, or the operating part is provided with a limiting part and a movable part, the limiting part is larger than the coupling part to limit the coupling part at a high or low position, and the movable part is communicated with the limiting part to make the coupling part move upwards to heighten a position of the coupling part, or the coupling part is provided with a first guiding part, the limiting part is provided with a second guiding part, the first guiding part and the second guiding part guide each other, and the first guiding part and the second guiding part are inclined surfaces, curved surface, stepped surfaces, or flat surfaces.

Optionally, the body is provided with a shoulder, and the actuating part is pressed against the shoulder to locate at a high position, or the actuating part rotates to move to a low position from an entry part of the body.

Optionally, the movement structure further includes an elastic element with one end pressed against the body and the other end pressed against the actuating part, or the elastic element is a spring, or the elastic element is a spring with two ends coupled to the body and the actuating part, or a torsion spring with two ends inserted into the body and the actuating part, so as to make the actuating part rotatable automatically, or to make the actuating part restorable automatically.

Optionally, the body is provided with at least one first stopping part, the actuating part is provided with at least one second stopping part, the first stopping part and the second stopping part are pressed against each other for limiting, or the movement structure is provided an elastic element, and the first stopping part and the second stopping part limit rotational elastic restoration or vertical elastic restoration of the actuating part to switch actuation of the moving part.

Optionally, the body or the actuating part is provided with a corresponding rotating part, a locking part, a screw locking part, a screw tooth part or a nut part for corresponding rotation, locking, screw locking, action locking, corresponding rotation, locking or action locking to switch actuation of the moving part.

Optionally, the actuating part is made of a metal material or a plastic material, and has a hardness greater than the hardness of the moving part, a hardness close to or the same as the hardness of the moving part, or a hardness less than the hardness of the moving part, or the actuating part or the body is formed through metal injection molding, or the actuating part and the body are formed through lathe or mill machining, or the actuating part or the body is formed through plastic injection molding, or the actuating part or the body is formed through injection molding; or the moving part is a buckling body, a spherical body, a spherical buckling body, a metal buckling body, a non-metal buckling body, a non-spherical buckling body, or a plastic buckling body.

Optionally, the actuating part is provided with a buckling part, the buckling part is configured to buckle another object, and the moving part is configured to restrict the movement, opening or closing of the buckling part.

Optionally, the buckling part is an elastic buckling body, an external threaded body, a cylindrical body, an internal threaded body, an external buckling body, or an internal buckling body.

Optionally, the actuating part is connected to an operating part, the operating part moves against the body or an object to drive the actuating part to move, or the operating part rotates against the body or the object to drive the actuating part to move.

Optionally, the actuating part is connected to the operating part through a combining part, or the combining part is bolted, buckled, locked, clamped or threaded to the actuating part or the operating part.

Optionally, the number of the operating parts is two or more, or the number of the bodies, the actuating parts, the combining parts or the moving parts corresponding to the actuating parts is two or more, and the actuating parts are connected, combined, or integrally formed with each other to form a handle or combined body.

Optionally, the actuating part is provided with an avoidance part, and the actuating part rotates or moves to make the avoidance part reach a position of the moving part for avoidance.

Optionally, the actuating part is combined with the body through a coupling part, or the actuating part is combined with the body through a combining part, or the coupling part is combined with the body, the actuating part and the combining part, and the actuating part rotates or moves to make the avoidance part reach the position of the moving part for avoidance.

Optionally, the movement structure further includes an elastic element with one end pressed against the body and the other end pressed against the coupling part to apply an elastic force to the actuating part.

Optionally, the operating part rotates against the body or object to lift the actuating part, the coupling part or the combining part, so as to make the avoidance part reach or leave the position of the moving part, or elastically press against, limit or leave the position of the moving part.

Optionally, the actuating part is provided with an avoidance part, and the avoidance part is a spatial area, a hole, a recess, a groove, or an open area.

Optionally, the actuating part is provided with an avoidance part, and the actuating part moves laterally, transversely, rotationally, or longitudinally to make the avoidance part reach the position of the moving part.

Optionally, the actuating part or the body is provided with a movement space, and a combining part moves in the movement space to make the actuating part to move laterally or transversely.

Optionally, the actuating part or the body is provided with a guiding part for guiding the actuating part to move laterally, transversely, or rotationally.

Optionally, the actuating part is provided with a coupling part, the coupling part is configured to be movably combined with the body, and the actuating part is provided with a limiting part and a movable part to make the coupling part move laterally or transversely, or the coupling part is provided with a first guiding part, the first guiding part is an inclined surface, and the first guiding part is configured to guide an inclined surface of the limiting part to actuate.

Optionally, the movement structure further includes an elastic element with two ends respectively pressed against the body and the actuating part, or the two ends of the elastic element are respectively pressed against the body and the coupling part, so as to make the actuating part perform transverse elastic movement or to make the actuating part perform transverse limited movement.

Optionally, the buckled part is buckled to the moving part, or the buckled part passes through another object or the object and is buckled to the moving part, or the movement structure passes through the other object or the object and is buckled to the buckled part.

Optionally, the actuating part is provided with an avoidance part, the number of the moving parts is two or more, or the body is provided with an anti-rotation part, and the anti-rotation part is configured to prevent the actuating part from rotating or to restrict the actuating part, or the avoidance part moves at a restricted position or an avoidance position, or a connecting part of the body is provided with an anti-rotation part configured to prevent an object from rotating or to restrict positions of the body or the actuating part and the object.

Optionally, the actuating part is a rotating body configured to rotate the actuating part against an object and lifting the coupling part, the moving part is located in the body and provided at the coupling part, and the coupling part drives the moving part to move.

Optionally, the actuating part is a rotating body configured to rotate the actuating part against an object and lifting the coupling part, and the coupling part is a buckling part configured to buckle the body, or the actuating part and the coupling part are connected to the body through a combining part, or an elastic element is provided, and two ends of the elastic element are respectively pressed against the body and the coupling part to apply an elastic force to the body, the actuating part, the coupling part, or the combining part.

Optionally, the number of the bodies is two or more, and the bodies are combined with the actuating part to form a handle or lifting handle component.

Optionally, the movement structure is assembled onto an object, and the object is a main board, a circuit board, a housing, a metal body, a plastic body, a chip, a heat sink, or an electric conductor.

Optionally, the actuating part is pressed against the moving part, and the body is connected to an object or integrally formed with the object to rotate or move the actuating part, so as to make the moving part pressed against a high position or a low position, or to press against a pressed object to increase a distance between the object and the pressed object; or the object is provided with a connecting component connected to the pressed object, or the pressed object is provided with another connecting component abutted with the connecting component, and the connecting component and the other connecting component are detached, moved or loosened through the moving part by pressing against the pressed object; or the actuating part is provided with at least one limiting part, and the limiting part is configured to limit the moving part at a high position or a low position; or the connecting component and the other connecting component are connectors, heat sinks, chips, printed circuit boards, electric conductors, metal bodies, or plastic bodies.

The present disclosure provides a movement method of another movement structure. The movement structure includes a body, an actuating part, and a moving part, where the actuating part is movably combined with the body, the moving part is arranged on the body, and the actuating part moves to make the moving part move or to make the moving part buckled to a buckled part.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, and the actuating part is connected to the operating part through a coupling part, or the operating part rotates against the body to drive the actuating part to move, or the operating part moves to generate high-position movement and low-position movement to drive the actuating part to move.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, and the actuating part is connected to an operating part through a coupling part, or the operating part moves to drive the actuating part to move, or the operating part is provided with a limiting part and a movable part, the limiting part is larger than the coupling part to limit the coupling part at a high or low position, or the movable part is communicated with the limiting part to make the coupling part move upwards to heighten a position of the coupling part, or the coupling part is provided with a first guiding part, or the limiting part is provided with a second guiding part, the first guiding part and the second guiding part guide each other, or the first guiding part and the second guiding part are inclined surfaces, curved surface, stepped surfaces, or flat surfaces.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, the body is provided with a shoulder, and the actuating part is pressed against the shoulder to locate at a high position, or the actuating part rotates to move to a low position from an entry part of the body.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, and the movement structure further includes an elastic element with one end pressed against the body and the other end pressed against the actuating part, or the elastic element is a spring, or the elastic element is a spring with two ends coupled to the body and the actuating part, or a torsion spring with two ends inserted into the body and the actuating part, so as to make the actuating part rotatable automatically, or to make the actuating part restorable automatically.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, the body is provided with at least one first stopping part, the actuating part is provided with at least one second stopping part, the first stopping part and the second stopping part are pressed against each other for limiting, or the movement structure is provided an elastic element, and the first stopping part and the second stopping part limit rotational elastic restoration or vertical elastic restoration of the actuating part to switch actuation of the moving part.

The present disclosure provides a movement method of another movement structure. The movement structure includes a body, an actuating part, and a moving part, where the actuating part is movably combined with the body, the moving part is arranged on the body, the actuating part moves to make the moving part move or to make the moving part buckled to a buckled part, and the body or the actuating part is provided with a corresponding rotating part, a locking part, a screw locking part, a screw tooth part or a nut part for corresponding rotation, locking, screw locking, action locking, corresponding rotation, locking or action locking to switch actuation of the moving part.

The present disclosure provides a movement method of another movement structure. The movement structure includes a body, an actuating part, and a moving part, where the actuating part is movably combined with the body, the moving part is arranged on the body, and the actuating part moves to make the moving part move or to make the moving part buckled to a buckled part; the actuating part is made of a metal material or a plastic material, and has a hardness greater than the hardness of the moving part, a hardness close to or the same as the hardness of the moving part, or a hardness less than the hardness of the moving part, or the actuating part or the body is formed through metal injection molding, or the actuating part and the body are formed through lathe or mill machining, or the actuating part or the body is formed through plastic injection molding, or the actuating part or the body is formed through injection molding, or the actuating part or the body is formed through injection molding; or the moving part is a buckling body, a spherical body, a spherical buckling body, a metal buckling body, a non-metal buckling body, a non-spherical buckling body, or a plastic buckling body.

The present disclosure provides a movement method of another movement structure. The movement structure includes a body, an actuating part, and a moving part, where the actuating part is movably combined with the body, the moving part is arranged on the body, and the actuating part moves to make the moving part move or to make the moving part buckled to a buckled part; the actuating part is provided with a buckling part, or the buckling part is configured to buckle another object, or the moving part is configured to restrict the movement, opening or closing of the buckling part; or the buckling part is an elastic buckling body, an external threaded body, a cylindrical body, an internal threaded body, an external buckling body, or an internal buckling body.

The present disclosure provides a movement method of another movement structure. The movement structure includes a body, an actuating part, and a moving part, where the actuating part is movably combined with the body, the moving part is arranged on the body, and the actuating part moves to make the moving part move, so as to make the moving part buckled to a buckled part; or the actuating part is connected to the operating part, and the operating part moves against the body or object to drive the actuating part to move, or the operating part rotates against the body or object to drive the actuating part to move; or the actuating part is connected to the operating part through a combining part, or the combining part is bolted, buckled, locked, clamped or threaded to the actuating part or the operating part; or the number of the actuating parts is two or more, or the number of the bodies, the actuating parts, the combining parts or the moving parts corresponding to the actuating parts is two or more, and the actuating parts are connected, combined, or integrally formed with each other to form a handle or combined body.

The present disclosure provides a movement method of another movement structure. The movement structure includes a body, an actuating part, and a moving part, where the actuating part is movably combined with the body, the moving part is arranged on the body, and the actuating part moves to make the moving part move, so as to make the moving part buckled to a buckled part; or the actuating part is provided with an avoidance part, the actuating part rotates or moves to make the avoidance part reach a position of the moving part for avoidance, or the actuating part is combined with the body through a coupling part; or the actuating part is combined with the body through a combining part, or the coupling part combines the body, the actuating part and the combining part, and rotates or moves the actuating part to make the avoidance part reach the position of the moving part for avoidance; or the movement structure further includes an elastic element with one end pressed against the body and the other end pressed against the coupling part to apply an elastic force to the actuating part; or the actuating part rotates or moves against the body or object to lift the actuating part, the coupling part or the combining part, so as to make the avoidance part reach or leave the position of the moving part, or elastically press against, limit or leave the position of the moving part.

The present disclosure provides a movement method of another movement structure. The movement structure includes a body, an actuating part, and a moving part, the actuating part is movably combined with the body, the moving part is arranged on the body, and the actuating part moves to make the moving part move or to make the moving part buckled to a buckled part; or the actuating part is provided with an avoidance part, and the avoidance part is a spatial area, a hole, a recess, a groove, or an open area; or the actuating part is provided with an avoidance part, and the actuating part moves laterally, transversely, rotationally or longitudinally to make the avoidance part reach the position of the moving part; or the actuating part or the body is provided with a movement space, and a combining part moves in the movement space to make the actuating part to move laterally or transversely; or the actuating part or the body is provided with a guiding part for guiding the actuating part to move laterally, transversely, or rotationally; or the actuating part is provided with a coupling part, and the coupling part is configured to be movably combined with the body, or the actuating part is provided with a limiting part and a movable part to make the coupling part move laterally or transversely, or the coupling part is provided with a first guiding part, or the first guiding part is an inclined surface, and the first guiding part is configured to guide an inclined surface of the limiting part to actuate; or the movement structure further includes an elastic element with two ends respectively pressed against the body and the actuating part, or the two ends of the elastic element are respectively pressed against the body and the coupling part, so as to make the actuating part perform transverse elastic movement or to make the actuating part perform transverse limited movement.

The present disclosure provides a movement method of another movement structure. The movement structure includes a body, an actuating part, and a moving part, where the actuating part is movably combined with the body, the moving part is arranged on the body, and the actuating part moves to make the moving part move, so as to make the moving part buckled to a buckled part; or the buckled part is buckled to the moving part, or the buckled part passes through another object or the object and is buckled to the moving part, or the movement structure passes through another object or the object and is buckled to the buckled part; or the actuating part is provided with an avoidance part, or the number of the moving parts is two or more, or the body is provided with an anti-rotation part, or the anti-rotation part is configured to prevent the actuating part from rotating or to restrict the actuating part, or the avoidance part moves at a restricted position or an avoidance position, or a connecting part of the body is provided with an anti-rotation part configured to prevent the object from rotating or to restrict positions of the body or the actuating part and the object; or the actuating part is a rotating body configured to rotate the actuating part against the object and lifting the coupling part, or the moving part is located in the body and provided at the coupling part, or the coupling part drives the moving part to move; or the actuating part is a rotating body configured to rotate the actuating part against the object and lifting the coupling part, or the coupling part is a buckling part configured to buckle the body, or the actuating part and the coupling part are connected to the body through a combining part, or an elastic element is provided, or two ends of the elastic element are respectively pressed against the body and the coupling part to apply an elastic force to the body, the actuating part, the coupling part, or the combining part; or the number of the bodies is two or more, or the bodies are combined with the actuating part to form a handle or lifting handle component; or the movement structure is assembled onto the object, and the object is a main board, a circuit board, a housing, a metal body, a plastic body, a chip, a heat sink, or an electric conductor.

The present disclosure provides a movement method of another movement structure. The movement structure includes a body, an actuating part, and a moving part, where the actuating part is movably combined with the body, the moving part is arranged on the body, and the actuating part moves to make the moving part move or to make the moving part buckled to a buckled part; or the actuating part is pressed against the moving part, and the body is connected to an object or integrally formed with the object to rotate or move the actuating part, so as to make the moving part pressed against a high position or a low position, or to press against a pressed object to increase a distance between the object and the pressed object; or the object is provided with a connecting component connected to the pressed object, or the pressed object is provided with another connecting component abutted with the connecting component, or the connecting component and the other connecting component are detached, moved or loosened through the moving part by pressing against the pressed object; or the actuating part is provided with at least one limiting part, or the limiting part is configured to limit the moving part at a high position or a low position; or the connecting component and the other connecting component are connectors, heat sinks, chips, printed circuit boards, electric conductors, metal bodies, or plastic bodies.

### BRIEF DESCRIPTION OF THE DRAWINGS

FIG. 1 is a schematic diagram I in a used state according to a first embodiment of the present disclosure.

FIG. 2 is a schematic diagram II in a used state according to a first embodiment of the present disclosure.

FIG. 3 is a schematic diagram in a used state according to a second embodiment of the present disclosure.

FIG. 4 is a schematic diagram I in a used state according to a third embodiment of the present disclosure.

FIG. 5 is a schematic diagram II in a used state according to a third embodiment of the present disclosure.

FIG. 6 is a schematic diagram I in a used state according to a fourth embodiment of the present disclosure.

FIG. 7 is a schematic diagram II in a used state according to a fourth embodiment of the present disclosure.

FIG. 8 is a schematic diagram I in a used state according to a fifth embodiment of the present disclosure.

FIG. 9 is a schematic diagram II in a used state according to a fifth embodiment of the present disclosure.

FIG. 10 is a schematic diagram in a used state according to a sixth embodiment of the present disclosure.

FIG. 11 is a schematic diagram I in a used state according to a seventh embodiment of the present disclosure.

FIG. 12 is a schematic diagram II in a used state according to a seventh embodiment of the present disclosure.

FIG. 13 is a schematic diagram in a used state according to an eighth embodiment of the present disclosure.

FIG. 14 is a schematic diagram in a used state according to a ninth embodiment of the present disclosure.

FIG. 15 is a schematic diagram of different forms of buckling parts according to the present disclosure.

FIG. 16 is a schematic diagram I in a used state according to a tenth embodiment of the present disclosure.

FIG. 17 is a schematic diagram II in a used state according to a tenth embodiment of the present disclosure.

FIG. 18 is a schematic diagram in a used state according to an eleventh embodiment of the present disclosure.

FIG. 19 is a schematic diagram in a used state according to a twelfth embodiment of the present disclosure.

FIG. 20 is a schematic diagram I in a used state according to a thirteenth embodiment of the present disclosure.

FIG. 21 is a schematic diagram II in a used state according to a thirteenth embodiment of the present disclosure.

FIG. 22 is a schematic diagram I in a used state according to a fourteenth embodiment of the present disclosure.

FIG. 23 is a schematic diagram II in a used state according to a fourteenth embodiment of the present disclosure.

FIG. 24 is a schematic diagram in a used state according to a fifteenth embodiment of the present disclosure.

FIG. 25 is a schematic diagram I in a used state according to a sixteenth embodiment of the present disclosure.

FIG. 26 is a schematic diagram II in a used state according to a sixteenth embodiment of the present disclosure.

FIG. 27 is a schematic diagram I in a used state according to a seventeenth embodiment of the present disclosure.

FIG. 28 is a schematic diagram II in a used state according to a seventeenth embodiment of the present disclosure.

FIG. 29 is a schematic diagram III in a used state according to a seventeenth embodiment of the present disclosure.

FIG. 30 is a schematic diagram in a used state according to an eighteenth embodiment of the present disclosure.

FIG. 31 is a schematic diagram in a used state according to a nineteenth embodiment of the present disclosure.

FIG. 32 is a schematic diagram I according to a twentieth embodiment of the present disclosure.

FIG. 33 is a schematic diagram II according to a twentieth embodiment of the present disclosure.

FIG. 34 is a schematic diagram III according to a twentieth embodiment of the present disclosure.

FIG. 35 is a schematic diagram IV according to a twentieth embodiment of the present disclosure.

FIG. 36 is a schematic diagram I in a used state according to a twenty-first embodiment of the present disclosure.

FIG. 37 is a schematic diagram II in a used state according to a twenty-first embodiment of the present disclosure.

FIG. 38 is a schematic diagram in a used state according to a twenty-second embodiment of the present disclosure.

FIG. 39 is a schematic diagram according to a twenty-third embodiment of the present disclosure.

FIG. 40 is a schematic diagram in a used state according to a twenty-fourth embodiment of the present disclosure.

FIG. 41 is a schematic diagram in a used state according to a twenty-fifth embodiment of the present disclosure.

### DETAILED DESCRIPTION OF THE INVENTION

A movement structure according to an embodiment of the present disclosure will be further described below with reference to the drawings.

The above and other technical contents, features, and effects related to the present disclosure will be clearly presented below in the detailed description of the exemplary embodiments with reference to the drawings. The directional language mentioned in the following embodiments, such as down, left, right, front and back are only directions with reference to the drawings. Therefore, the directional language used is intended to describe rather than limit the present disclosure. In addition, in the following embodiments, identical or similar components will be labeled with the same or similar reference numerals.

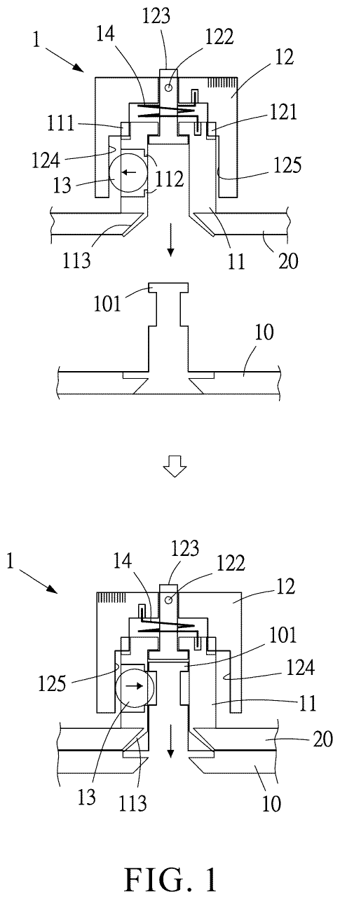

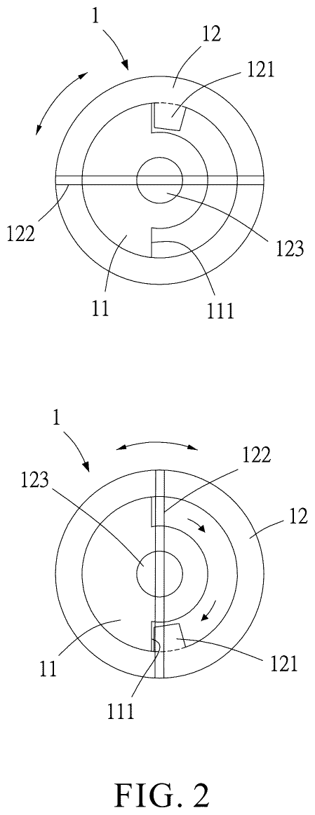

Refer to FIG. 1 and FIG. 2. The present disclosure provides a movement structure and a movement method thereof. The movement structure 1 includes a body 11, an actuating part 12, and a moving part 13.

The actuating part 12 is movably combined with the body 11. For example, the actuating part 12 is movably combined at a top end of the body 11.

The moving part 13 is arranged on one side of the body 11. The actuating part 12 actuates to make the moving part 13 move, so as to make the moving part 13 buckled to a buckled part 101.

When in use, the movement structure 1 may be assembled onto an object 20, and the object 20 is a main board, a circuit board, a housing, a metal body, a plastic body, a chip, a heat sink, or an electric conductor. In the present disclosure, the movement structure 1 is connected to the object 20 through the body 11, and a method using the movement structure 1 includes applying a force (rotating force) to the actuating part 12, so that the actuating part 12 moves to drive the moving part 13 to move, thereby making the moving part 13 buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

In addition to the above embodiments, in an embodiment of the present disclosure, a difference from the above embodiments lies in that the buckled part 101 may be arranged on another object 10 as needed, and the moving part 13 is buckled to or unbuckled from the buckled part 101 through the actuating part 12 to achieve rapid combination and separation of at least two objects, thereby ensuring repetitive and rapid combination and separation.

In addition to the above embodiments, in an embodiment of the present disclosure, a difference from the above embodiments lies in that the body 11 is provided with at least one first stopping part 111, the actuating part 12 is provided with at least one second stopping part 121, and the first stopping part 111 and the second stopping part 121 may be pressed against each other for limiting. In this way, by applying the force to rotate the actuating part 12, when the actuating part 12 rotates and moves to a predetermined position, the first stopping part 111 and the second stopping part 121 are pressed against each other for limiting, and the actuating part 12 drives the moving part 13 according to a predetermined movement travel, so that the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

In addition to the above embodiments, in an embodiment of the present disclosure, a difference from the above embodiments lies in that the actuating part 12 is connected to a coupling part 123 through a combining part 122, and the actuating part 12 is movably combined with the body 11 through the coupling part 123 under the cooperation between the combining part 122 and the coupling part 123. In this way, under the cooperation between the combining part 122 and the coupling part 123, when the actuating part 12 rotates and moves to a predetermined position, the first stopping part 111 and the second stopping part 121 are pressed against each other for limiting, and the actuating part 12 drives the moving part 13 according to a predetermined movement travel, so that the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

In addition to the above embodiments, in an embodiment of the present disclosure, a difference from the above embodiments lies in that the movement structure 1 further includes an elastic element 14 (e.g., torsion spring), two ends of the elastic element 14 are respectively arranged on the actuating part 12 and the body 11, two sides of an inner edge of the actuating part 12 are provided with n avoidance part 124 and a pushing part 125, the avoidance part 124 corresponds to the moving part 13, and the pushing part 125 pushes the moving part 13, so as to use the elastic element 14 to make the actuating part 12 normally located at a position corresponding to the moving part 13 (in an unbuckled state) through the avoidance part 124, or to use the elastic element 14 to make the actuating part 12 normally located at a position of pushing the moving part 13 (in a buckled state) through the pushing part 125. In this way, by rotating the actuating part 12 under the cooperation between the combining part 122 and the coupling part 123, when the actuating part 12 rotates and moves to a predetermined position, the first stopping part 111 and the second stopping part 121 are pressed against each other for limiting, the avoidance part 124 is moved away from the moving part 13 to move the pushing part 125 to the position of pushing the moving part 13, and the actuating part 12 drives the moving part 13 according to a predetermined movement travel, so that the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

In addition to the above embodiments, in an embodiment of the present disclosure, a difference from the above embodiments lies in that the body 11 is provided with a restricting part 112, and the moving part 13 is movably arranged on one side of the body 11 through the restricting part 112; and the body 11 is further provided with a connecting part 113, and the body 11 is stably combined with the object 20 through the connecting part 113 by flaring or welding.

In addition to the above embodiments, in an embodiment of the present disclosure, a difference from the above embodiments lies in that one end of the elastic element 14 is pressed against the body 11, the other end is pressed against the actuating part 12, and the elastic element 14 may be a spring, or the elastic element 14 may be a spring with two ends coupled to the body 11 and the actuating part 12, or a torsion spring with two ends inserted into the body 11 and the actuating part 12 to make the actuating part 12 rotatable automatically, or to make the actuating part 12 restorable automatically.

In addition to the above embodiments, in an embodiment of the present disclosure, a difference from the above embodiments lies in that the first stopping part 111 and the second stopping part 121 are pressed against each other for limiting, and the first stopping part 111 and the second stopping part 121 limit rotational elastic restoration or vertical elastic restoration of the actuating part 12 through the elastic element 14 to switch actuation of the moving part 13.

In addition to the above embodiments, in an embodiment of the present disclosure, a difference from the above embodiments lies in that the actuating part 12 may be made of a metal material or a plastic material, and has a hardness greater than the hardness of the moving part 13, a hardness close to or the same as the hardness of the moving part 13, or a hardness less than the hardness of the moving part 13, or the actuating part 12 or the body 11 is formed through metal injection molding, or the actuating part 12 and the body 11 are formed through lathe or mill machining, or the actuating part 12 or the body 11 is formed through plastic injection molding, or the actuating part 12 or the body 11 is formed through injection molding; or the moving part 13 is a buckling body, a spherical body, a spherical buckling body, a metal buckling body, a non-metal buckling body, a non-spherical buckling body, or a plastic buckling body.

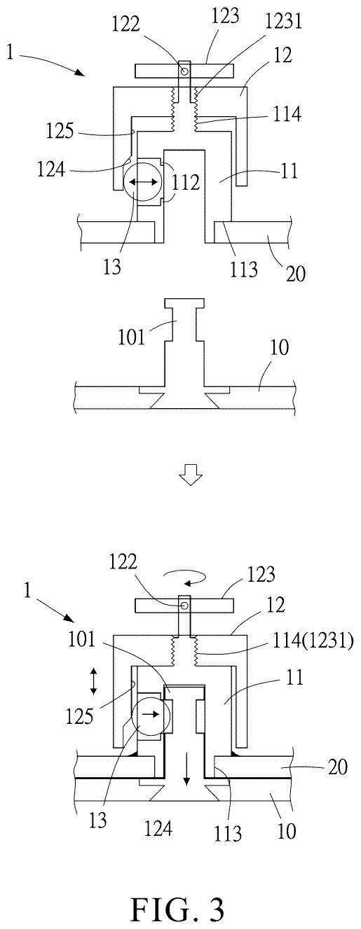

Refer to FIG. 3. In addition to the above embodiments, in an embodiment of the present disclosure, a difference from the above embodiments lies in that the body 11 (or the actuating part 12) is provided with a corresponding rotating part 114 (or a locking part, a screw locking part, a screw tooth part, or a nut part) for corresponding rotation, locking, screw locking, action locking, corresponding rotation, locking, or action locking to switch actuation of the moving part 13; the coupling part 123 is movably combined with the corresponding rotating part 114 of the body 11 through a rotating part 1231 (for example, movable combination is achieved by threaded connection or locking), so as to rotatably move the actuating part 12 upwards (when unbuckling) and downwards (when buckling), so that the actuating part 12 drives the moving part 13 to be buckled to the buckled part 101; and one side of an inner edge of the actuating part 12 is provided with the avoidance part 124 and the pushing part 125, and the avoidance part 124 is located below the pushing part 125.

Based on the above embodiments, the actuating part 12 may be rotated during buckling, so that the actuating part 12 can move downwards after rotation under the cooperation between the rotating part 1231 and the corresponding rotating part 114. During downward movement, the avoidance part 124 moves away from the moving part 13, so that the pushing part 125 moves to the position of pushing the moving part 13, the actuating part 12 drives the moving part 13 according to a predetermined movement travel, and the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

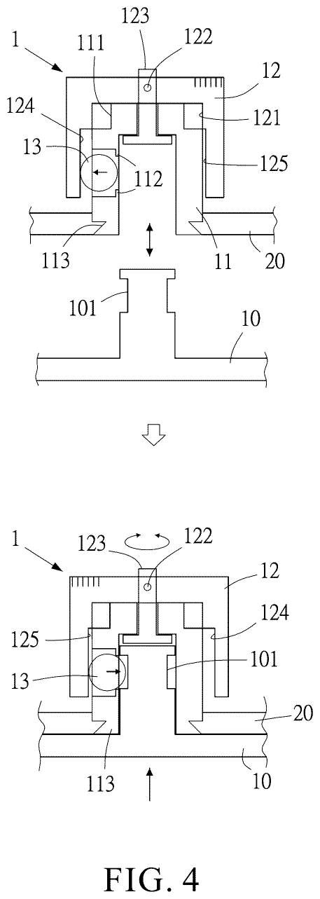

Refer to FIG. 4 and FIG. 5. In addition to the above embodiments, in an embodiment of the present disclosure, a difference from the above embodiments lies in that the first stopping part 111 of the body 11 and the second stopping part 121 of the actuating part 12 are elastically deformable, so that the first stopping part 111 and the second stopping part 121 are elastically deformable and movable. In this way, by rotating the actuating part 12 under the cooperation between the combining part 122 and the coupling part 123, the second stopping part 121 can leave the first stopping part 111 due to elastic deformation; when the actuating part 12 rotates and moves to a predetermined position, the second stopping part 121 falls into another first stopping part 111 again due to elastic deformation, the first stopping part 111 and the second stopping part 121 are pressed against each other for limiting, the avoidance part 124 is moved away from the moving part 13 to move the pushing part 125 to the position of pushing the moving part 13, and the actuating part 12 drives the moving part 13 according to a predetermined movement travel, so that the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

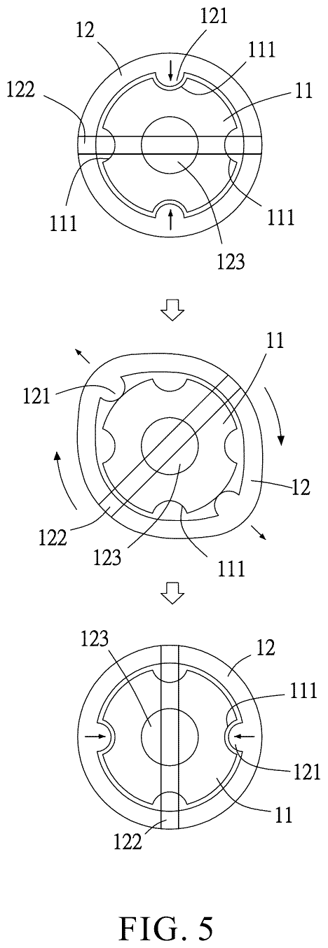

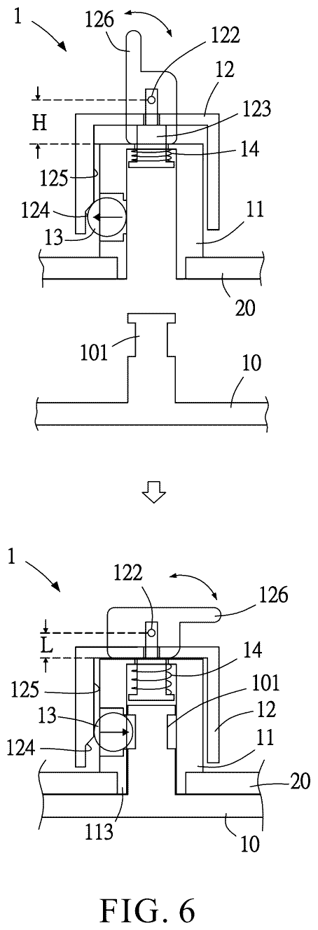

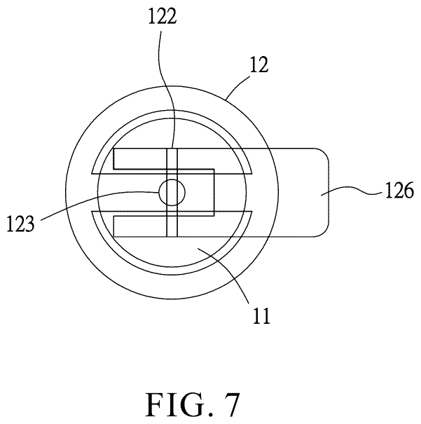

Refer to FIG. 6 and FIG. 7. In addition to the above embodiments, in an embodiment of the present disclosure, a difference from the above embodiments lies in that the actuating part 12 is connected to an operating part 126 through the coupling part 123, and the operating part 126 rotates against the body 11 to drive the actuating part 12 to move, so that the operating part 126 moves to generate high-position movement and low-position movement to drive the actuating part 12 to move; and the operating part 126 may be rotated against the body 11, so that the actuating part 12 is located at a high position H (unbuckled state) or a low position L (buckled State).

Based on the above embodiments, the operating part 126 may be rotated during buckling, so that the operating part 126 can be pressed against the body 11 and the actuating part 12 moves downwards to the low position L from the high position H. During downward movement, the avoidance part 124 moves away from the moving part 13, so that the pushing part 125 moves to the position of pushing the moving part 13, the actuating part 12 drives the moving part 13 according to a predetermined movement travel, and the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

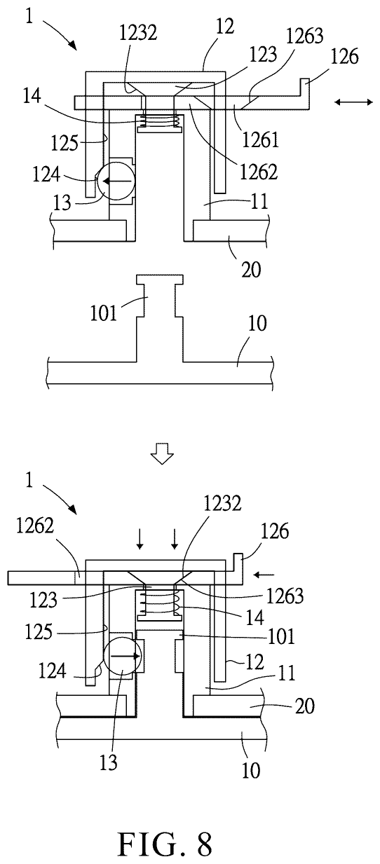

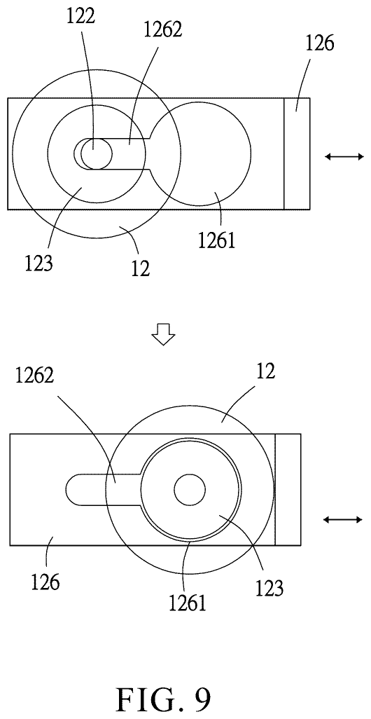

Refer to FIG. 8 and FIG. 9. In addition to the above embodiments, in an embodiment of the present disclosure, a difference from the above embodiments lies in that the actuating part 12 is connected to the operating part 126 through the coupling part 123, so that the operating part 126 moves to drive the actuating part 12 to move; the operating part 126 is provided with a limiting part 1261 and a movable part 1262, the limiting part 1261 may be larger than the coupling part 123 to limit the coupling part 123 at a high or low position, and the movable part 1262 is communicated with the limiting part to make the coupling part 123 move upwards to heighten the position of the coupling part 123. In the present disclosure, the coupling part 123 is provided with a first guiding part 1232, the limiting part 1261 is provided with a second guiding part 1263, the first guiding part 1232 and the second guiding part 1263 guide each other to make the coupling part 123 move upwards to heighten the position of the coupling part 123.

For example, the operating part 126 may be moved rightwards to make the first guiding part 1232 and the second guiding part 1263 guide each other, so that the operating part 126 restricts the coupling part 123 through the limiting part 1261, the position of the coupling part 123 is heightened to drive the actuating part 12 to move upwards, and the avoidance part 124 corresponds to the moving part 13, thereby making the moving part 13 located at an unbuckled position; when the operating part 126 moves leftwards, the first guiding part 1232 and the second guiding part 1263 are separated from each other, and the operating part 126 corresponds to the coupling part 123 through the movable part 1262, so that the position of the coupling part 123 is lowered to drive the actuating part 12 to move downwards, and the avoidance part 124 moves away from the moving part 13, thereby making the pushing part 125 move downwards to push the moving part 13 to a buckled position.

Based on the above embodiments, the operating part 126 may be moved leftwards during buckling, so that the coupling part 123 moves to the movable part 1262 from the limiting part 1261 and the actuating part 12 moves downwards to the low position L from the high position H. During downward movement, the avoidance part 124 moves away from the moving part 13, so that the pushing part 125 moves to the position of pushing the moving part 13, the actuating part 12 drives the moving part 13 according to a predetermined movement travel, and the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

In addition to the above embodiments, in an embodiment of the present disclosure, a difference from the above embodiments lies in that the first guiding part 1232 and the second guiding part 1263 may be inclined surfaces, curved surfaces, stepped surfaces, or flat surfaces. In this way, the first guiding part 1232 and the second guiding part 1263 can better meet the actual use requirements.

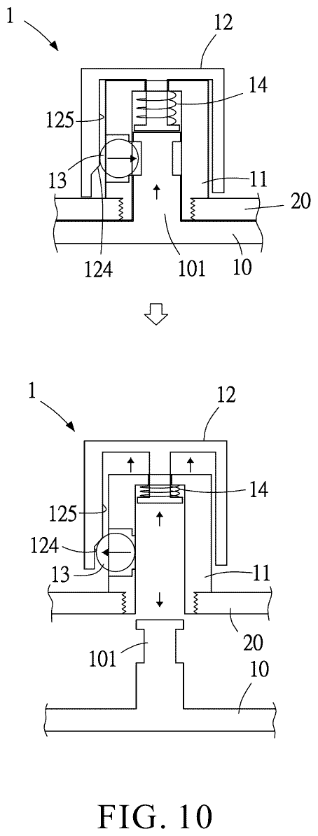

Refer to FIG. 10. In addition to the above embodiments, in an embodiment of the present disclosure, a difference from the above embodiments lies in that the elastic element 14 may be a compression spring, two ends of the elastic element 14 are respectively pressed against the actuating part 12 and the body 11, and the elastic element 14 is used to make the actuating part 12 normally located at a position of pushing the moving part 13 (in a buckled state) through the pushing part 125, or the elastic element 14 is used to make the actuating part 12 normally located at a position corresponding to the moving part 13 (in an unbuckled state) through the avoidance part 124. In this way, the force can be directly applied to pull the actuating part 12, so that the actuating part 12 can move upwards. At the same time, the avoidance part 124 is moved away from the moving part 13, so that the pushing part 125 moves to the position of pushing the moving part 13, the actuating part 12 drives the moving part 13 according to a predetermined movement travel, and the actuating part 12 drives the moving part 13 to be buckled to the buckled part 101 (or in the case of movement in an opposite direction, it is unbuckled from the buckled part 101). In this way, the moving part 13 can be buckled to or unbuckled from the buckled part 101 through the actuating part 12, so as to achieve rapid combination and separation of at least two objects, thereby ensuring repetitive and rapid combination and separation.

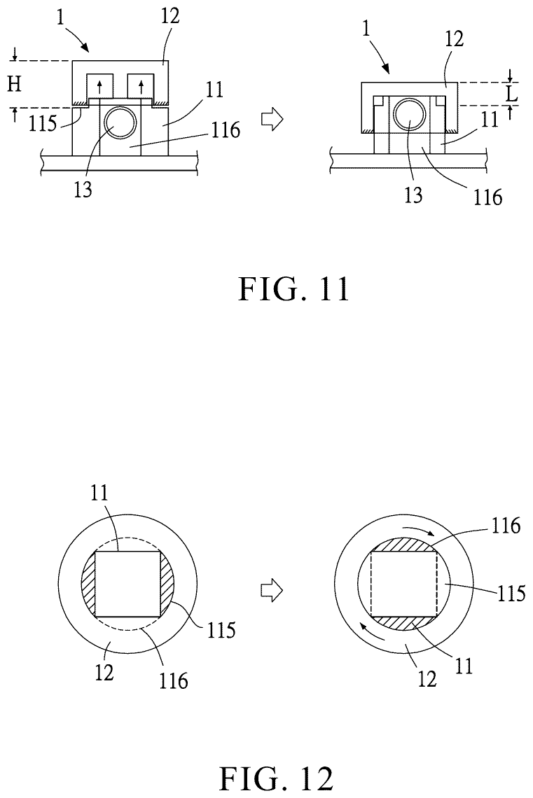

Refer to FIG. 11 and FIG. 12. In addition to the above embodiments, in an embodiment of the present disclosure, a difference from the above embodiments lies in that the body 11 is provided with a shoulder 115, and the actuating part 12 may be rotated to press against the shoulder 115, so that the actuating part 12 is located at the high position H (or the low position L); or the actuating part 12 may be rotated to move to the low position L through an entry part 116 of the body 11, and the entry part 116 may be any surface or flat surface; when the actuating part 12 is pressed against the shoulder 115 and located at the high position H, the moving part 13 may be in an unbuckled state; and when the actuating part 12 moves away from the shoulder 115 and is located at the low position L, the moving part 13 may be in a buckled state.

Based on the above embodiments, the force can be directly applied to rotate the actuating part 12 during buckling, so that the actuating part 12 moves away from the shoulder 115, the actuating part 12 falls into the entry part 116 of the body 11, the actuating part 12 moves downwards and is located at the low position L, and the actuating part 12 is moved to drive the moving part 13 to be buckled to the buckled part 101. In this way, the moving part 13 can be buckled to or unbuckled from the buckled part 101 through the actuating part 12, so as to achieve rapid combination and separation of at least two objects, thereby ensuring repetitive and rapid combination and separation.

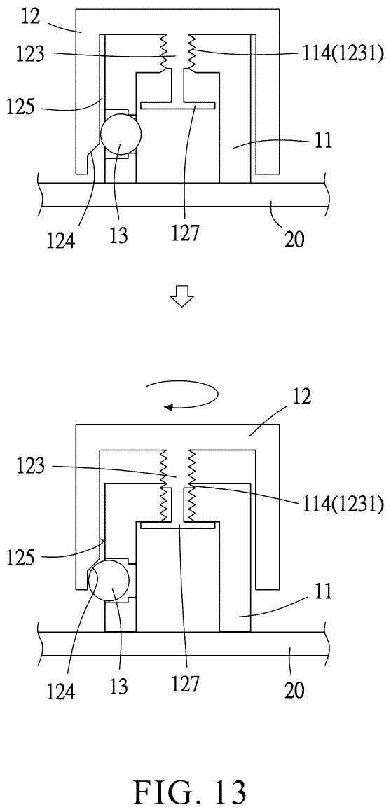

Refer to FIG. 13. In addition to the above embodiments, in an embodiment of the present disclosure, a difference from the above embodiments lies in that the coupling part 123 of the actuating part 12 is combined with the corresponding rotating part 114 of the body 11 through the rotating part 1231 (for example, movable combination is achieved by threaded connection or locking), and the actuating part 12 may be rotated during buckling, so that the actuating part 12 drives the buckling part 127 to move downwards after rotation under the cooperation between the rotating part 1231 and the corresponding rotating part 114. During downward movement, the avoidance part 124 moves away from the moving part 13, so that the pushing part 125 moves to the position of pushing the moving part 13, the actuating part 12 drives the moving part 13 according to a predetermined movement travel, and the actuating part 12 drives the moving part 13 to be buckled or unbuckled. In this way, rapid combination and separation of at least two objects can be achieved, thereby ensuring repetitive and rapid combination and separation.

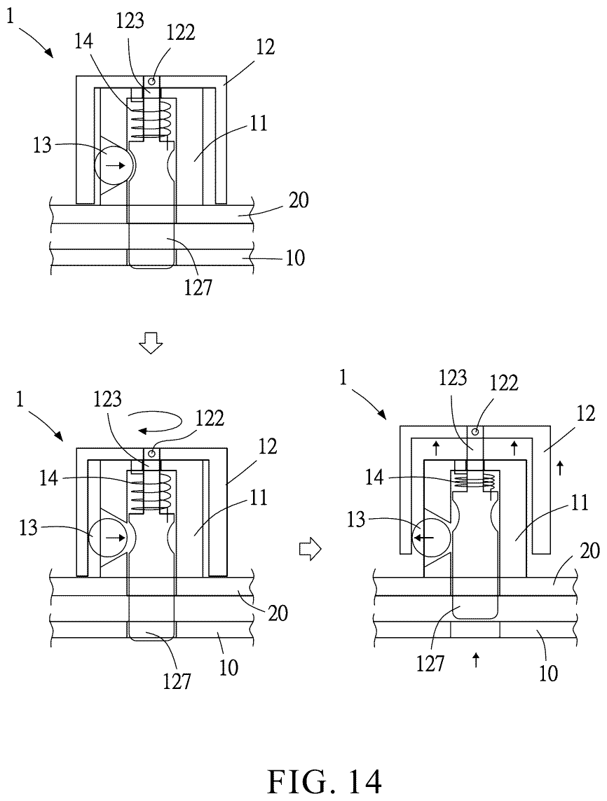

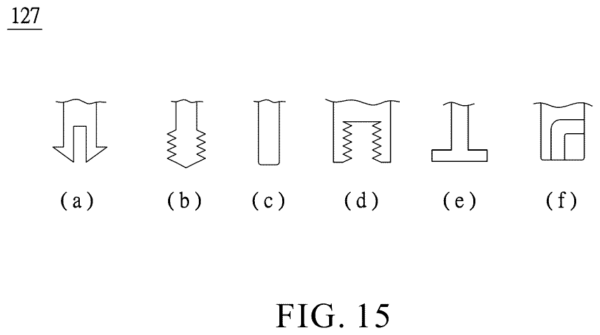

Refer to FIG. 14 and FIG. 15. In addition to the above embodiments, in an embodiment of the present disclosure, a difference from the above embodiments lies in that the actuating part 12 is provided with a buckling part 127, the buckling part 127 may be configured to buckle another object 10, and the moving part 13 is used as a switch for restricting the movement, opening, or closing of the buckling part 127. In this way, rapid combination and separation of at least two objects can be achieved, thereby ensuring repetitive and rapid combination and separation.

In addition to the above embodiments, in an embodiment of the present disclosure, a difference from the above embodiments lies in that the buckling part 127 may be an elastic buckling body (part a shown in FIG. 15), an external threaded body (part b shown in FIG. 15), a cylindrical body (part c shown in FIG. 15), an internal threaded body (part d shown in FIG. 15), an external buckling body (part e shown in FIG. 15), or an internal buckling body (part f shown in FIG. 15). In this way, the buckling part 127 can better meet the actual use requirements.

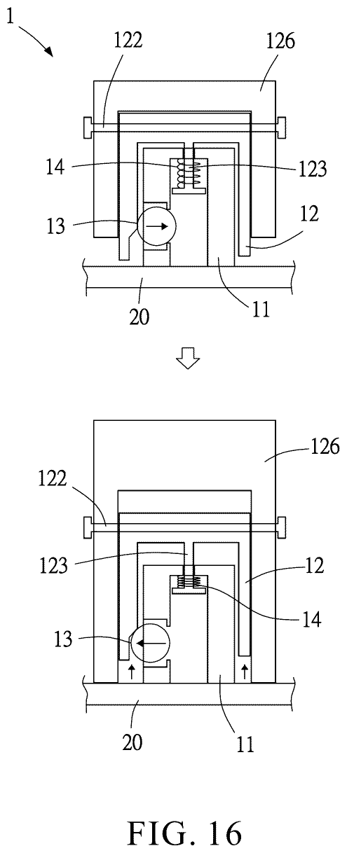

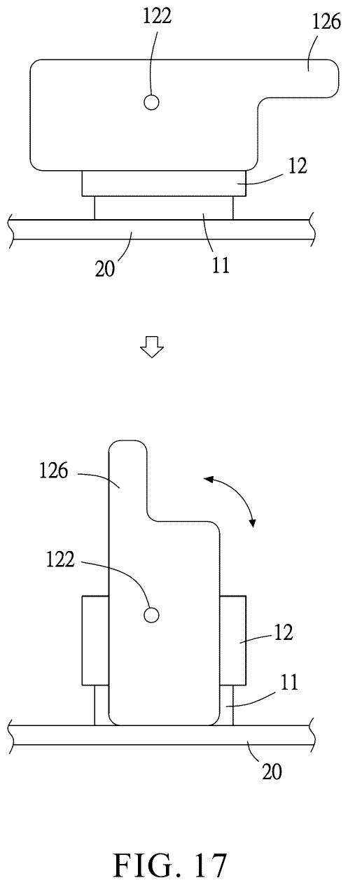

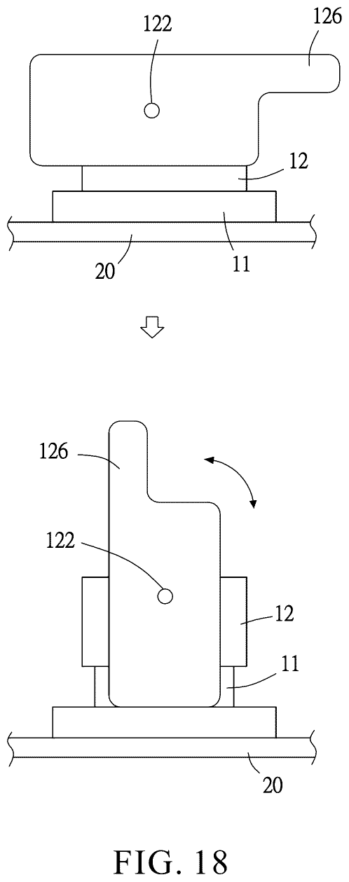

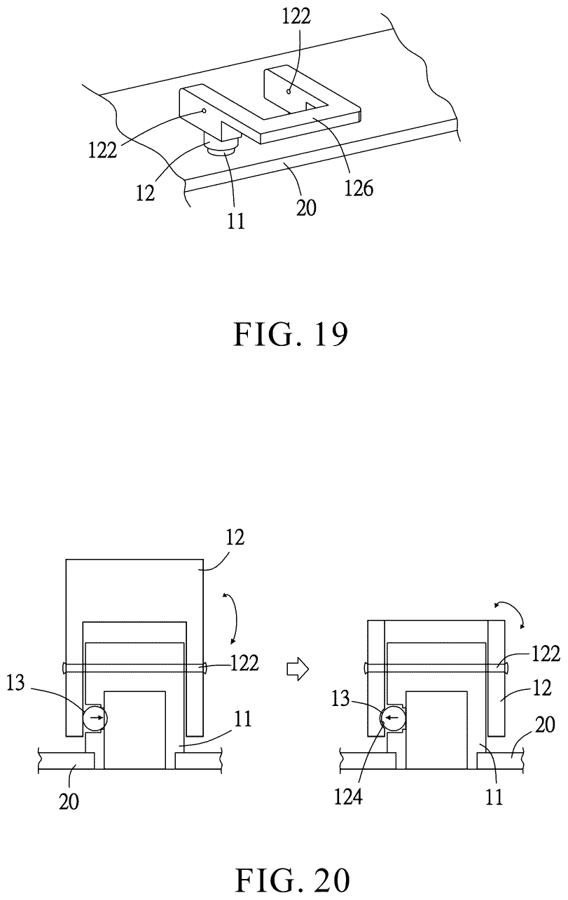

Refer to FIG. 16 to FIG. 19. In addition to the above embodiments, in an embodiment of the present disclosure, a difference from the above embodiments lies in that the actuating part 12 is connected to the operating part 126, and the operating part 126 moves against (for example, rotates against) the object 20 to drive the actuating part 12 to move (as shown in FIG. 17); in addition, the actuating part 12 is connected to the operating part 126, and the operating part 126 moves against (for example, rotates against) the body 11 to drive the actuating part 12 to move (as shown in FIG. 18). In this way, the actuating part 12 can drive the moving part 13 according to a predetermined movement travel, so that the actuating part 12 can drive the moving part 13 to be buckled or unbuckled, so as to achieve rapid combination and separation of at least two objects, thereby ensuring repetitive and rapid combination and separation.

In addition to the above embodiments, in an embodiment of the present disclosure, a difference from the above embodiments lies in that the operating part 126 is connected to the actuating part 12 through the combining part 122, and the combining part 122 may be bolted, buckled, locked, clamped or threaded to the operating part 126 (or the actuating part 12). In this way, the operating part 126 can drive the actuating part 12 under the cooperation with the combining part 122 to achieve required movement and pressing.

In addition to the above embodiments, in an embodiment of the present disclosure, a difference from the above embodiments lies in that, referring to FIG. 18, in a case that the number of the operating parts 126 is two or more, the number of the bodies 11, the actuating parts 12, the combining parts 122, or the moving parts 13 corresponding to the operating parts 126 is also two or more, so that the operating parts 126 cooperate with the combining parts 122 to link the actuating parts 12, and then the actuating parts 12 respectively drive the moving parts 13 to be buckled or unbuckled. In addition, in the present disclosure, the operating parts 126 may be connected, combined, or integrally formed to form a handle (or combined body) as needed.

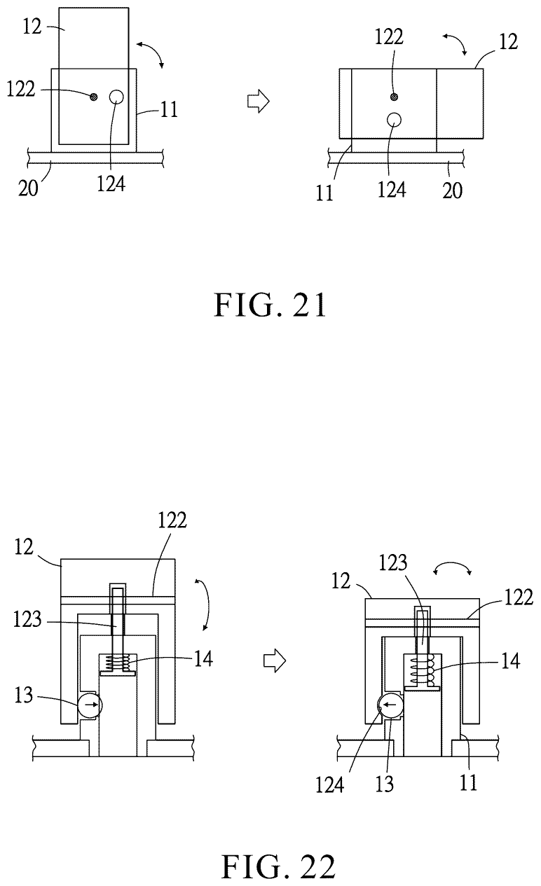

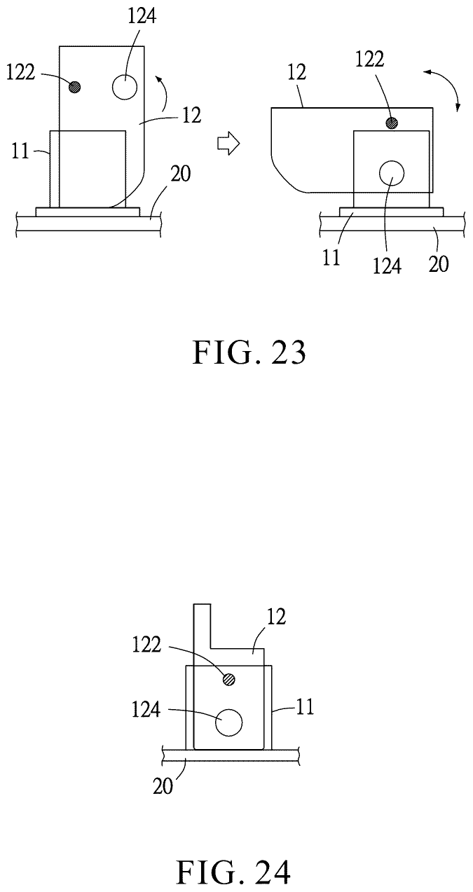

Refer to FIG. 20 to FIG. 24. In addition to the above embodiments, in an embodiment of the present disclosure, a difference from the above embodiments lies in that the actuating part 12 is provided with an avoidance part 124, and the actuating part 12 rotates (or moves) to make the avoidance part 124 reach the position of the moving part 13 for avoidance.

In addition to the above embodiments, in an embodiment of the present disclosure, a difference from the above embodiments lies in that the actuating part 12 is combined with the body 11 through the coupling part 123, the actuating part 12 is combined with the body 11 through the combining part 122, the coupling part 123 is combined with the body 11, the actuating part 12 and the combining part 122, and the actuating part 12 is rotated (or moved) to make the avoidance part 124 reach the position of the moving part 13 for avoidance.

In addition to the above embodiments, in an embodiment of the present disclosure, a difference from the above embodiments lies in that one end of the elastic element 14 is pressed against the body, and the other end is pressed against the coupling part 123 to apply an elastic force to the actuating part 12.

In addition to the above embodiments, in an embodiment of the present disclosure, a difference from the above embodiments lies in that the operating part 126 rotates (or moves) against the body 11 (or the object 20) to lift the actuating part 12, the coupling part 123, and the combining part 122, so as to make the avoidance part 124 reach (or leave) the position of the moving part 13; and in addition, it may also cooperate with the elastic element 14 to make the avoidance part 124 elastically press against, limit, or move away from the position of the moving part 13.

In addition to the above embodiments, in an embodiment of the present disclosure, a difference from the above embodiments lies in that the avoidance part 124 may be a spatial area, a hole, a recess, a groove, or an open area, so that the avoidance part 124 can meet the requirements of different moving parts 13.

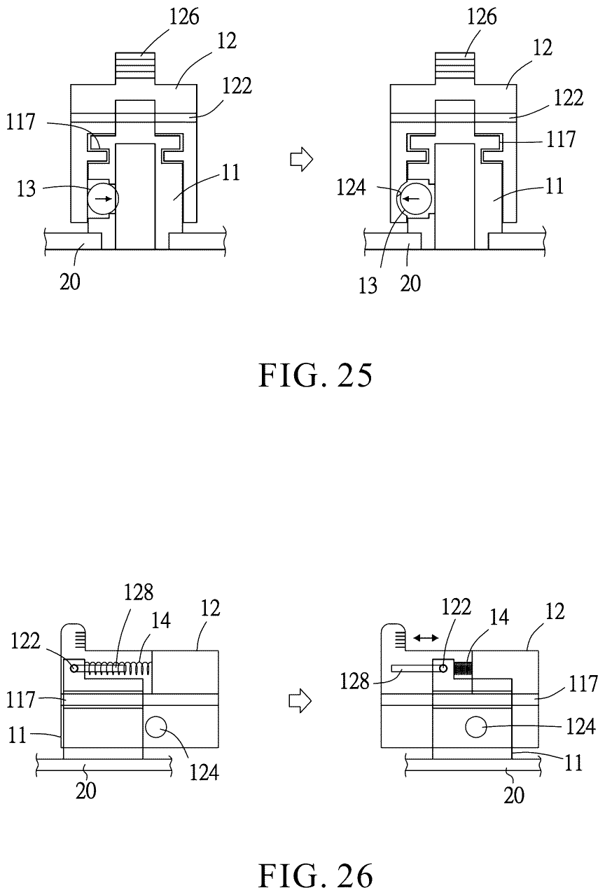

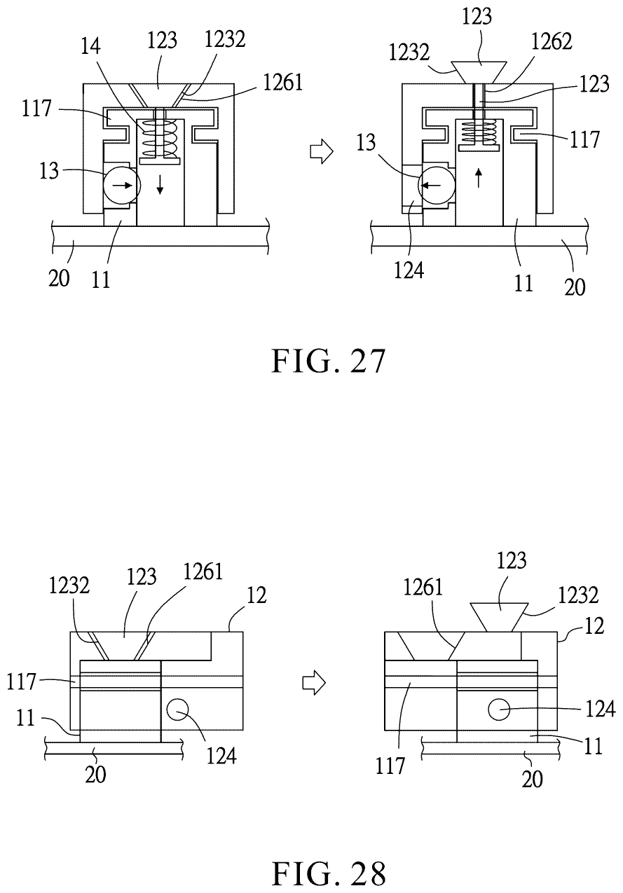

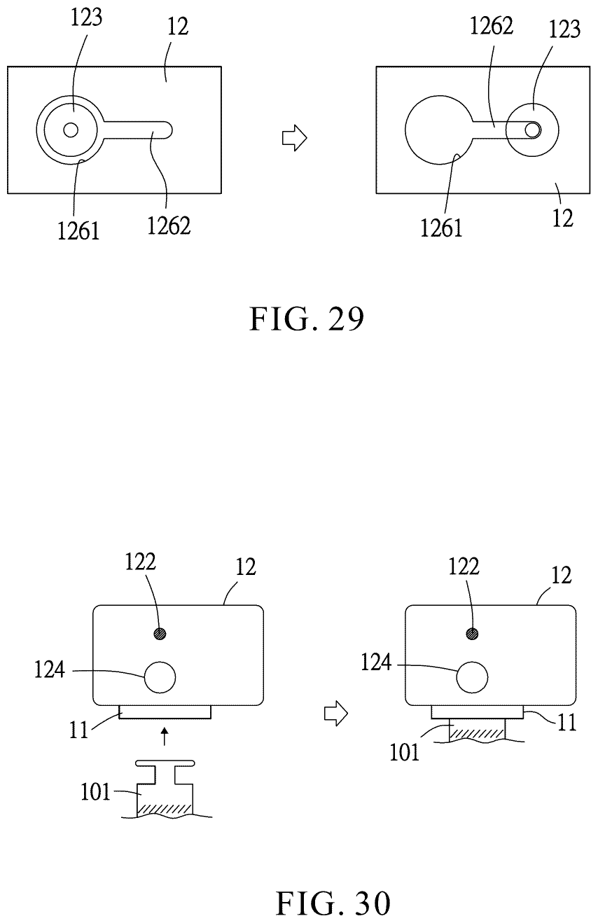

Refer to FIG. 25 to FIG. 29. In addition to the above embodiments, in an embodiment of the present disclosure, a difference from the above embodiments lies in that the actuating part 12 is provided with an avoidance part 124, and the actuating part 12 moves laterally or transversely to make the avoidance part 124 reach the position of the moving part 13.

In addition to the above embodiments, in an embodiment of the present disclosure, a difference from the above embodiments lies in that the actuating part 12 or the body 11 is provided with a movement space 128, and the combining part 122 moves in the movement space 128 to make the actuating part 12 to move laterally, transversely, rotationally, or longitudinally.

In addition to the above embodiments, in an embodiment of the present disclosure, a difference from the above embodiments lies in that the actuating part 12 or the body 11 is provided with a guiding part 117 configured to guide the actuating part 12 to move laterally, transversely, or rotationally.

In addition to the above embodiments, in an embodiment of the present disclosure, a difference from the above embodiments lies in that the actuating part 12 is provided with a coupling part 123, the coupling part 123 is configured to be movably combined with the body 11, and the actuating part 12 is provided with a limiting part 1261 and a movable part 1262 to make the coupling part 123 move laterally or transversely, or the coupling part 123 is provided with a first guiding part 1232, the first guiding part 1232 is an inclined surface, and the first guiding part 1232 is configured to guide an inclined surface of the limiting part 1261 to actuate. In addition to the above embodiments, in an embodiment of the present disclosure, a difference from the above embodiments lies in that the movement structure further includes an elastic element 14 with two ends respectively pressed against the body 11 and the actuating part 12, or the two ends of the elastic element 14 are respectively pressed against the body 11 and the coupling part 123 to make the actuating part 12 achieve transverse elastic movement or to make the actuating part 12 achieve transverse limited movement.

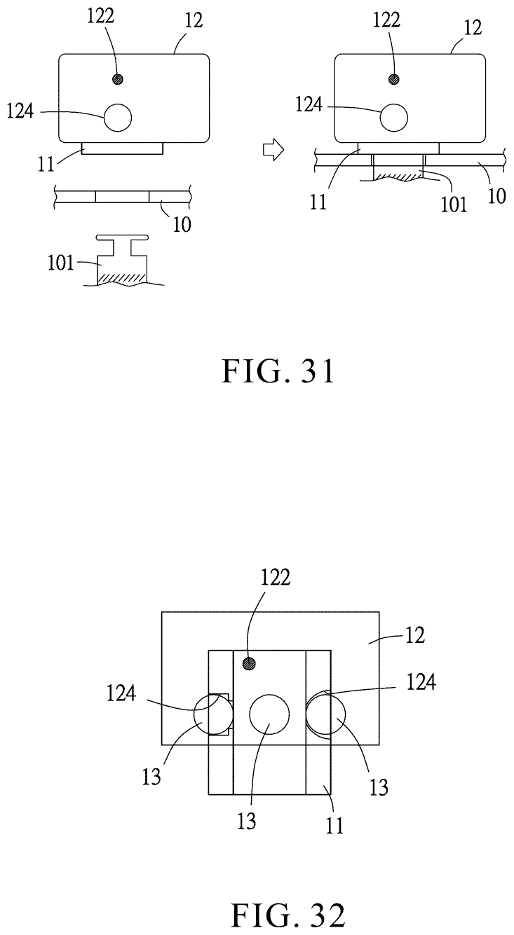

Refer to FIG. 30 and FIG. 31. In addition to the above embodiments, in an embodiment of the present disclosure, a difference from the above embodiments lies in that the buckled part 101 is buckled to the moving part 13, or the buckled part 101 passes through the other object 10 (object 20) and is buckled to the moving part 13, or the movement structure 1 passes through the other object 10 (or object 20) and is buckled to the buckled part 101.

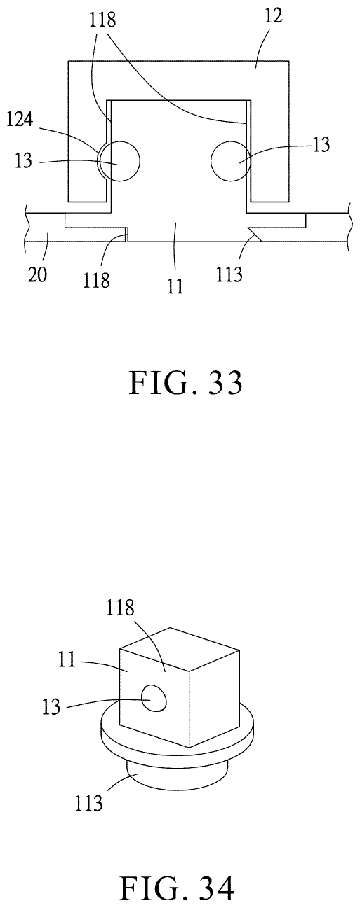

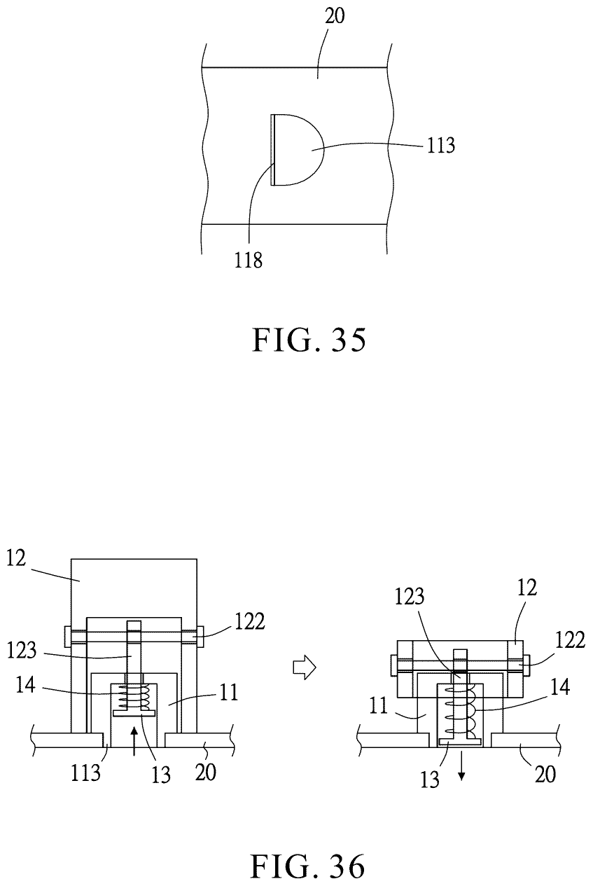

Refer to FIG. 32 to FIG. 35. In addition to the above embodiments, in an embodiment of the present disclosure, a difference from the above embodiments lies in that the actuating part 12 is provided with an avoidance part 124, the number of the moving parts 13 is two or more, the body 11 is provided with an anti-rotation part 118, the anti-rotation part 118 is configured to prevent the actuating part 12 from rotating to restrict the actuating part 12, and the avoidance part 124 moves at a restricted position or an avoidance position, or the connecting part 113 of the body 11 is provided with an anti-rotation part 118 configured to prevent the object 20 from rotating or to restrict positions of the body 11 or the actuating part 12 and the object 20.

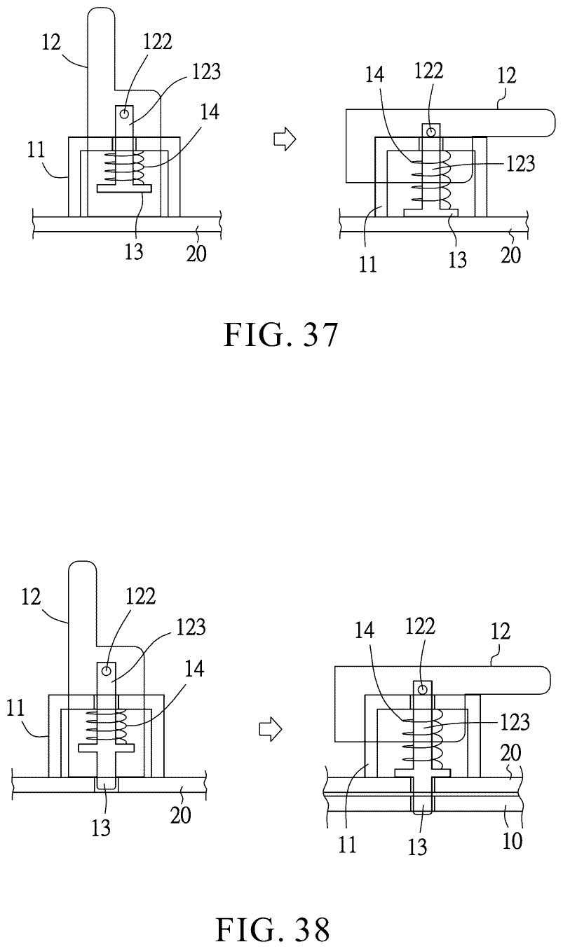

Refer to FIG. 36 to FIG. 38. In addition to the above embodiments, in an embodiment of the present disclosure, a difference from the above embodiments lies in that the actuating part 12 is a rotating body configured to rotate the actuating part 12 against the object 20 and lifting the coupling part 123, the moving part 13 is located in the body 11 and provided at the coupling part 123, and the coupling part 123 drives the moving part 13 to move.

In addition to the above embodiments, in an embodiment of the present disclosure, a difference from the above embodiments lies in that the coupling part 123 may be a buckling part configured to buckle the body 11, the actuating part 12 and the coupling part 123 are connected to the body 11through the combining part 122, and two ends of the elastic element 14 are respectively pressed against the body 11 and the coupling part 123 to apply an elastic force to the body 11, the actuating part 12, the coupling part 123, or the combining part 122.

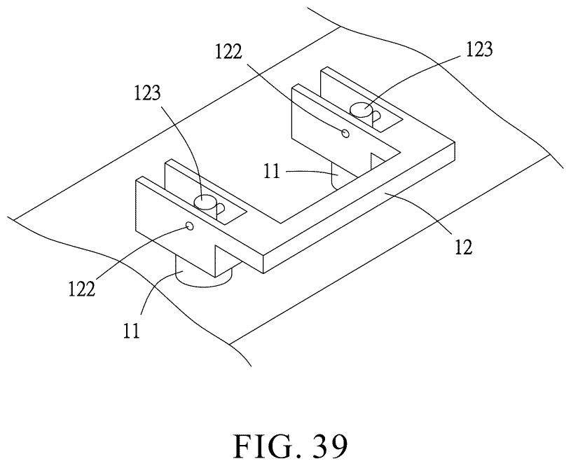

Refer to FIG. 39. In addition to the above embodiments, in an embodiment of the present disclosure, a difference from the above embodiments lies in that the number of the bodies 11 is two or more, and the bodies 11 are combined with the actuating part 12 to form a handle or lifting handle component.

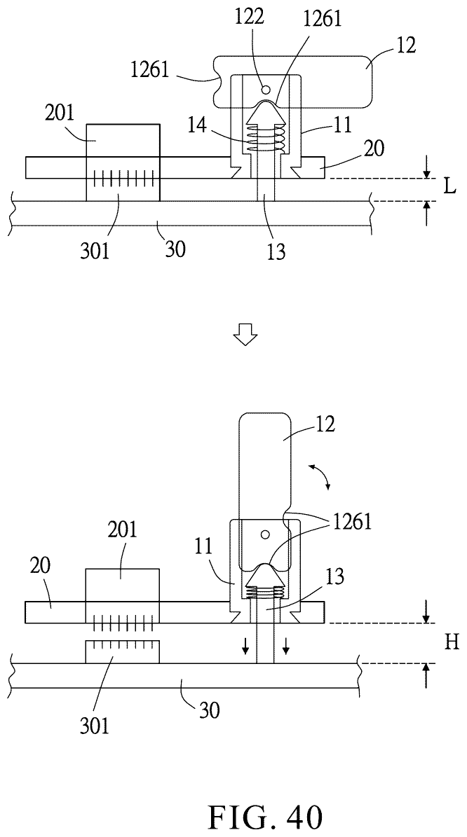

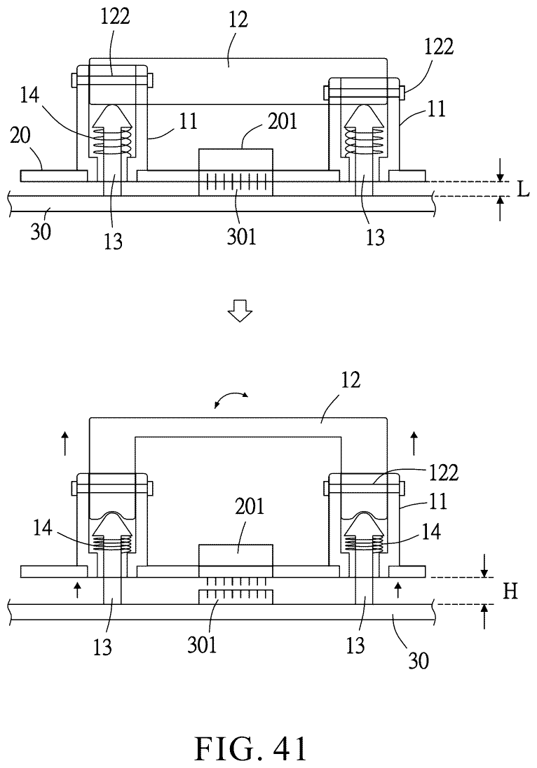

Refer to FIG. 40 and FIG. 41. In addition to the above embodiments, in an embodiment of the present disclosure, a difference from the above embodiments lies in that the actuating part 12 is pressed against the moving part 13, and the body 11 is connected to the object 20 (or integrally formed with the object 20) to rotate or move the actuating part 12 to make the moving part 13 pressed against a high position H or a low position L or to make the moving part 13 pressed against a pressed object 30 to increase (or decrease) a distance between the object 20 and the pressed object 30.

In addition to the above embodiments, in an embodiment of the present disclosure, a difference from the above embodiments lies in that the object 20 is provided with a connecting component 201 connected to the pressed object 30, the pressed object 30 is provided with another connecting component 301 abutted with the connecting component 201, and the connecting component 201 and the other connecting component 301 are detached, moved or loosened through the moving part 13 by pressing against the pressed object 30.

In addition to the above embodiments, in an embodiment of the present disclosure, a difference from the above embodiments lies in that the actuating part 12 is provided with at least one limiting part 1261, the limiting part 1261 is configured to limit the moving part 13 at a high position H or a low position L, and the connecting component 201 and the other connecting component 301 are connectors, heat sinks, chips, printed circuit boards, electric conductors, metal bodies, or plastic bodies.

To sum up, in the movement structure according to the present disclosure, the body can be arranged on the object, and the moving part can be buckled to or unbuckled from the buckled part through the actuating part, so as to achieve rapid combination and separation of at least two objects, thereby ensuring repetitive and rapid combination and separation.

What are described above are merely embodiments of the present disclosure, and are not intended to limit the scope of protection of the present disclosure.

What is claimed is:

1. A movement structure, comprising:
a body;
an actuating part movably combined with the body; and
a moving part arranged on the body, the actuating part moving to make the moving part move or to make the moving part buckled to a buckled part.

2. The movement structure according to claim 1, wherein the body is provided with at least one first stopping part, or the actuating part is provided with at least one second stopping part, or the first stopping part and the second stopping part are elastically deformable, or the first stopping part and the second stopping part are elastically deformable and movable.

3. The movement structure according to claim 1, wherein the actuating part is connected to an operating part through a coupling part, or the operating part rotates against the body or any object to drive the actuating part to move, or the operating part moves to generate high-position movement and low-position movement to drive the actuating part to move; or the actuating part is connected to an operating part through a coupling part, or the operating part moves to drive the actuating part to move, or the operating part is provided with a limiting part and a movable part, or the limiting part is larger than the coupling part to limit the coupling part at a high or low position, or the movable part is communicated with the limiting part to make the coupling part move upwards to heighten a position of the coupling part, or the coupling part is provided with a first guiding part, or the limiting part is provided with a second guiding part, or the first guiding part and the second guiding part guide each other, or the first guiding part and the second guiding part are inclined surfaces, curved surface, stepped surfaces, or flat surfaces.

4. The movement structure according to claim 1, wherein the body is provided with a shoulder, and the actuating part is pressed against the shoulder to locate at a high position, or the actuating part rotates to move to a low position from an entry part of the body; or the actuating part is pressed against the shoulder to locate at a high position of an object or any object, or the actuating part rotates to move to a low position from the entry part of the body; or the movement structure further comprises an elastic element with one end pressed against the body and the other end pressed against the actuating part, or the elastic element is a spring, or the elastic element is a spring with two ends coupled to the body and the actuating part, or a torsion spring with two ends inserted into the body and the actuating part, so as to make the actuating part rotatable automatically, or to make the actuating part restorable automatically.

5. The movement structure according to claim 1, wherein the body is provided with at least one first stopping part, or the actuating part is provided with at least one second stopping part, or the first stopping part and the second stopping part are pressed against each other for limiting, or the movement structure is provided an elastic element, and the first stopping part and the second stopping part limit rotational elastic restoration or vertical elastic restoration of the actuating part to switch actuation of the moving part; or the body or the actuating part is provided with a corresponding rotating part, a locking part, a screw locking part, a screw tooth part or a nut part for corresponding rotation, locking, screw locking, action locking, corresponding rotation, locking or action locking to switch actuation of the moving part; or the number of the bodies is two or more, or the bodies are combined with the actuating part to form a handle or lifting handle component.

6. The movement structure according to claim 1, wherein the actuating part is made of a metal material or a plastic material, and has a hardness greater than the hardness of the moving part, a hardness close to or the same as the hardness of the moving part, or a hardness less than the hardness of the moving part, or the actuating part or the body is formed through metal injection molding, or the actuating part and the body are formed through lathe or mill machining, or the actuating part or the body is formed through plastic injection molding, or the actuating part or the body is formed through injection molding; or the moving part is a buckling body, a spherical body, a spherical buckling body, a metal buckling body, a non-metal buckling body, a non-spherical buckling body, or a plastic buckling body; or the actuating part is provided with a buckling part, or the buckling part is configured to buckle another object, or the moving part is configured to restrict the movement, opening or closing of the buckling part; or the buckling part is an elastic buckling body, an external threaded body, a cylindrical body, an internal threaded body, an external buckling body, or an internal buckling body.

7. The movement structure according to claim 1, wherein the actuating part is connected to the operating part, and the operating part moves against the body or object to drive the actuating part to move, or the operating part rotates against the body or object to drive the actuating part to move; or the actuating part is connected to the operating part through a combining part, or the combining part is bolted, buckled, locked, clamped or threaded to the actuating part, or the number of the operating parts is two or more, or the number of the bodies, the actuating parts, the combining parts or the moving parts corresponding to the operating parts is two or more, and the actuating parts are connected, combined, or integrally formed with each other to form a handle or combined body.

8. The movement structure according to claim 1, wherein the actuating part is provided with an avoidance part, the actuating part rotates or moves to make the avoidance part reach a position of the moving part for avoidance, or the actuating part is combined with the body through a coupling part; or the actuating part is combined with the body through a combining part, or the coupling part combines the body, the actuating part and the combining part, and rotates or moves the actuating part to make the avoidance part reach the position of the moving part for avoidance; or the movement structure further comprises an elastic element with one end pressed against the body and the other end pressed against the coupling part to apply an elastic force to the actuating part; or the actuating part rotates or moves against the body or object to lift the actuating part, the coupling part or the combining part, so as to make the avoidance part reach or leave the position of the moving part, or elastically press against, limit or leave the position of the moving part.

9. The movement structure according to claim 1, wherein the actuating part is provided with an avoidance part, and the avoidance part is a spatial area, a hole, a recess, a groove, or an open area; or the actuating part is provided with an avoidance part, and the actuating part moves laterally, transversely, rotationally, or longitudinally to make the avoidance part reach the position of the moving part; or the actuating part or the body is provided with a movement space, and a combining part moves in the movement space to make the actuating part to move laterally or transversely; or the actuating part or the body is provided with a guiding part for guiding the actuating part to move laterally, transversely, or rotationally.

10. The movement structure according to claim 1, wherein the actuating part is provided with a coupling part, the coupling part is configured to be movably combined with the body, or the actuating part is provided with a limiting part and a movable part to make the coupling part move laterally or transversely, or the coupling part is provided with a first guiding part, or the first guiding part is an inclined surface, and the first guiding part is configured to guide an inclined surface of the limiting part to actuate; the movement structure further comprises an elastic element with two ends respectively pressed against the body and the actuating part, or the two ends of the elastic element are respectively pressed against the body and the coupling part, so as to make the actuating part perform transverse elastic movement or to make the actuating part perform transverse limited movement.

11. The movement structure according to claim 1, wherein the buckled part is buckled to the moving part, or the buckled part passes through another object or an object and is buckled to the moving part, or the movement structure passes through the other object or the object and is buckled to the buckled part.

12. The movement structure according to claim 1, wherein the actuating part is provided with an avoidance part, or the number of the moving parts is two or more, or the body is provided with an anti-rotation part, or the anti-rotation part is configured to prevent the actuating part from rotating or to restrict the actuating part, or the avoidance part moves at a restricted position or an avoidance position, or a connecting part of the body is provided with an anti-rotation part configured to prevent an object from rotating or to restrict positions of the body or the actuating part and the object.

13. The movement structure according to claim 1, wherein the actuating part is a rotating body configured to rotate the actuating part against an object and lifting the coupling part, or the moving part is located in the body and provided at the coupling part, or the coupling part drives the moving part to move; the actuating part is a rotating body configured to rotate the actuating part against an object and lifting the coupling part, or the coupling part is a buckling part configured to buckle the body, or the actuating part and the coupling part are connected to the body through a combining part, or an elastic element is provided, or two ends of the elastic element are respectively pressed against the body and the coupling part to apply an elastic force to the body, the actuating part, the coupling part, or the combining part.

14. The movement structure according to claim 1, wherein the movement structure is assembled onto an object, and the object is a main board, a circuit board, a housing, a metal body, a plastic body, a chip, a heat sink, or an electric conductor; or the actuating part is pressed against the moving part, and the body is connected to the object or integrally formed with the object to rotate or move the actuating part, so as to make the moving part pressed against a high position or a low position, or to press against a pressed object to increase a distance between the object and the pressed object; or the object is provided with a connecting component connected to the pressed object, or the pressed object is provided with another connecting component abutted with the connecting component, or the connecting component and the other connecting component are detached, moved or loosened through the moving part by pressing against the pressed object; or the actuating part is provided with at least one limiting part, or the limiting part is configured to limit the moving part at a high position or a low position; or the connecting component and the other connecting component are connectors, heat sinks, chips, printed circuit boards, electric conductors, metal bodies, or plastic bodies.
